(19) United States
(12) Patent Application Publication
(10) Pub. No.: US 2007/0103903 A1
(43) Pub. Date: May 10, 2007

(54) Battery tea light

(76) Inventor: Kelli E. Caudill, Upper Marlboro, MD (US)

Correspondence Address: JAMES RAY & ASSOCIATES, 2640 PITCAIRN ROAD, MONROEVILLE, PA, 15146, US

(21) Appl. No.: 11/595,597

(22) Filed: Nov. 9, 2006

Related U.S. Application Data
(60) Provisional application No. 60/735,334, filed on Nov. 10, 2005.

(51) Int. Cl. F21V 33/00

(52) U.S. Cl. 362/253

(57) ABSTRACT

An apparatus for simulating tea candles without having the hazards that are associated with a lit candle. The apparatus comprises a holder member having each of a predetermined shape and a predetermined size and formed of a predetermined material. A light bulb is engageable with such holder member and has each of a predetermined size and a predetermined shape. A power source is disposed in the holder for providing power to such light bulb and there is a wiring means engageable with the power source and with the light bulb for providing electrical current therebetween. A switch is disposed on an exterior surface of the holder member and is engageable with the wiring means for opening and closing the electrical circuit between the power source and the light bulb.

### CROSS REFERENCE TO RELATED APPLICATIONS

This application is closely related to and claims benefit from U.S. Provisional Application Ser. No. 60/735,334 filed Nov. 9, 2005.

### FIELD OF THE INVENTION

The present invention relates, in general, to a tea light and shower, and, more particularly, the present invention relates to a battery operated tea light which resembles a candle but is not a fire hazard since there is no flame.

### BACKGROUND OF THE INVENTION

Tea light candles are often used when using a wax potpourri heater. These small candles can be a problem since they represent a distinct fire hazard and should not be used around children. However, they are frequently used because many people enjoy the fragrance of the potpourri.

Further, these candles do not last for a very long time and must be replaced frequently since they have a limited burn time. The cost of replacing these candles can become quite expensive.

Thus, it would be advantageous if there were a means for heating and melting the potpourri without the need of a flame and, further, if there were a unit which would resemble the flame of the tea light.

### SUMMARY OF THE INVENTION

In a first aspect the present invention provides an apparatus for simulating tea candles without having the hazards that are associated with a lit candle. The apparatus comprises a holder member having each of a predetermined shape and a predetermined size and formed of a predetermined material. A light and heat source is engageable with such holder member and has each of a predetermined size and a predetermined shape. A power source is disposed in the holder for providing power to such light and heat source and there is a wiring means engageable with the power source and with the light and heat source for providing current from the power means to the light and heat source. A switch is disposed on an exterior surface of the holder member and is engageable with the wiring means for opening and closing the electrical circuit between the power source and the light and heat source.

### OBJECTS OF THE INVENTION

It is, therefore, one of the primary objects of the present invention to provide a tea light that is an alternative to candles.

Another object of the present invention is to provide a battery operated light that resembles a tea candle.

Still another object of the present invention is to provide a tea light which can supply heat to a wax potpourri without the danger of a lit candle.

Yet another object of the present invention is to provide constant and stable heat and light which is safe.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus providing a tea light according to an embodiment of the invention.

FIG. 2 is a top view of the tea light apparatus shown in FIG. 1.

FIG. 3 is a side view of the tea light apparatus shown in FIG. 1.

FIG. 4 is a bottom view of the tea light apparatus shown in FIG. 1 showing the power source.

FIG. 5 is a perspective view of the tea light apparatus shown in FIG. 1 in its use with a potpourri heater.

FIG. 6 is a perspective view on the tea light apparatus shown in FIG. 1 in one of the possible applications of such tea light.

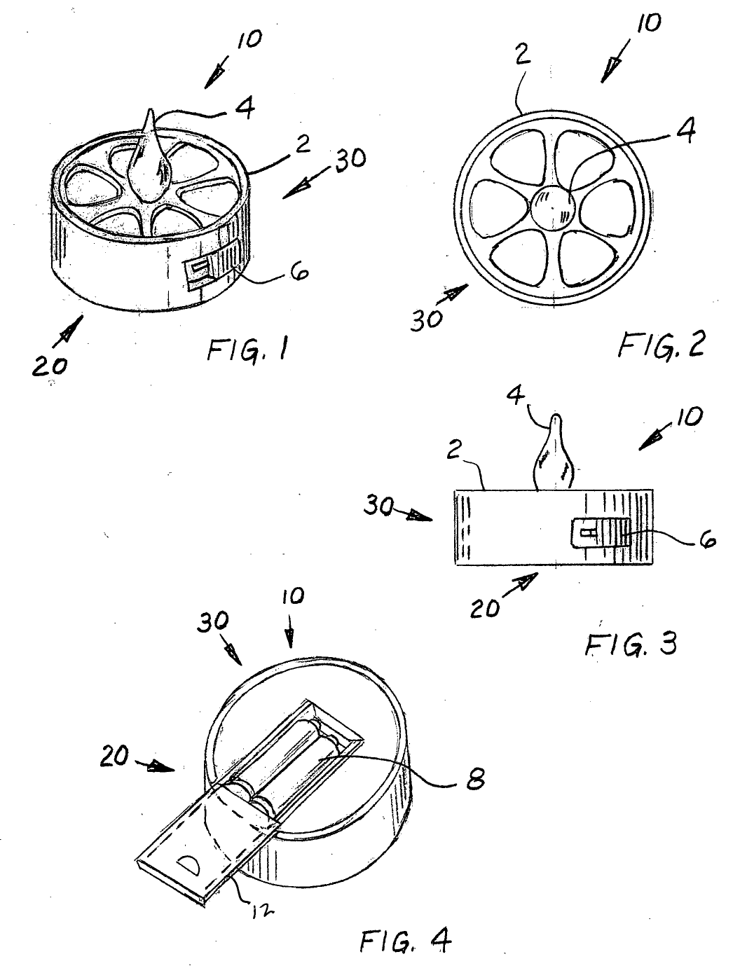

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for simulating tea candles without having the hazards that are associated with a lit candle. The apparatus 10 comprises a holder member 2 having each of a predetermined shape and a predetermined size and formed of a predetermined material. A heat and light source 4 is engageable with such holder member 2 and has each of a predetermined size and a predetermined shape. A power source, generally designated 20, is disposed in the holder member 2 for providing power to such heat and light source 4 and there is a wiring means, generally designated 30, that is engageable with the power source 20 and with the heat and light source 4 for providing electrical current from the power source to the heat and light source. A switch 6 is disposed on an exterior surface of the holder member 2 and is engageable with the wiring means 30 for opening and closing the electrical circuit between the power source 20 and the heat and light source 4.

It is presently preferred that such heat and light source 4 is a light bulb and wherein the predetermined shape of the light bulb 4 is designed so that it simulates the flame of a tea candle. It can be used to provide a safe method for heating a wax potpourri heater, see FIG. 5, without the danger incurred when using a lit candle for such procedure. The light bulb 4 provides enough heat to melt the wax causing it to release the fragrance that is associated with such potpourri heaters.

It is preferred that such power source 20 is at least one dry cell battery 8 and that such battery 8 is a AA battery and even further it is preferred that two AA batteries 8 are used in the holder member 2. Although AA batteries are preferred for convenience it is within the scope of the invention that other size batteries could just as easily be used. Such batteries 8 are disposed in the bottom portion of the holder member 2 and are easily accessible by just sliding the cover 12 away so as to have access to the batteries 8.

The predetermined shape of the holder member 2 is substantially cylindrical and the switch 6 that is disposed on the exterior surface of the holder member 2 is selected from one of a toggle switch, a pushbutton or a sliding switch. It is preferred that such switch is a sliding switch 6. The sliding switch 6 can be slid to the on position and slid back to the off position. Such switch 6 is disposed on the side surface of the substantially cylindrical holder member 2 for easy access.

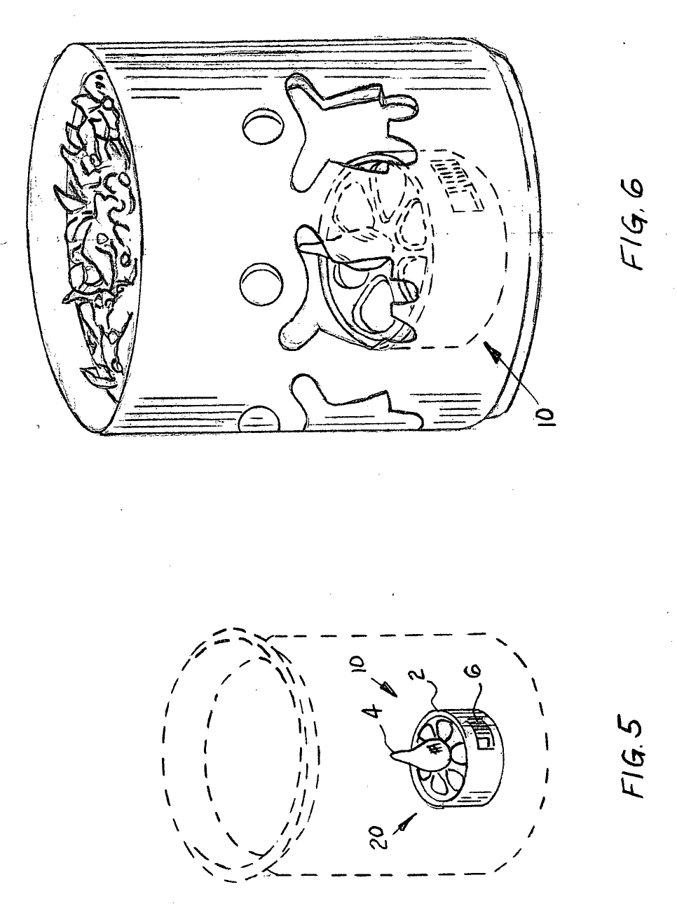

Such predetermined material that is used to form the holder member 2 is selected from one of plastic, aluminum, tinplate, or steel. It is presently preferred that such holder member 2 be formed of plastic. FIG. 6 shows one of the many applications in which such tea light can be used where a candle was previously used.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for simulating tea candles without having hazards associated with a lit candle, said apparatus comprising:
(a) a holder member having each of a predetermined shape and a predetermined size and formed of a predetermined material;
(b) a heat and light source engageable with said holder member and having each of a predetermined size and a predetermined shape;
(c) a power source disposed in said holder for providing power to said heat and light source;
(d) a wiring means engageable with said power source and with said heat and light source for providing current from said power means to said heat and light source;
(e) a switch disposed on an exterior surface of said holder member and engageable with said wiring means for opening and closing said electrical circuit between said power source and said heat and light source.

2. The apparatus, according to claim 1, wherein said heat and light source is a light bulb.

3. The apparatus, according to claim 2, wherein said predetermined shape of said light bulb simulates a flame of a tea candle.

4. The apparatus, according to claim 1, wherein said power source is at least one dry cell battery.

5. The apparatus, according to claim 4, wherein said battery is an AA battery.

6. The apparatus, according to claim 5, wherein two AA batteries are used in said apparatus.

7. The apparatus, according to claim 1, wherein said switch is one of a push button switch, a toggle switch, and a sliding switch.

8. The apparatus, according to claim 7, wherein said switch is a sliding switch.

9. The apparatus, according to claim 1, wherein said heat and light source provides a safe method of heating a wax potpourri heater.

10. The apparatus, according to claim 5, wherein said battery is disposed in a base portion of said holder.

11. The apparatus, according to claim 1, wherein said predetermined shape of said holder is substantially cylindrical.

12. The apparatus, according to claim 8, wherein said switch is disposed on a side surface of said substantially cylindrical holder.

13. The apparatus, according to claim 1, wherein said predetermined material for said holder member is selected from one of plastic, aluminum and steel.

14. The apparatus, according to claim 13, wherein said predetermined material is plastic.
